(19) United States
(12) Patent Application Publication
(10) Pub. No.: US 2007/0281815 A1
(43) Pub. Date: Dec. 6, 2007

(54) HYDROSTATIC MECHANICAL GEARBOX

(75) Inventor: Wilhelm Gollner, Neumunster (DE)

Correspondence Address: ZARLEY LAW FIRM P.L.C., CAPITAL SQUARE, 400 LOCUST, SUITE 200, DES MOINES, IA, 50309-2350, US

(73) Assignee: Sauer-Danfoss Inc., Ames, IA (US)

(21) Appl. No.: 11/682,654

(22) Filed: Mar. 6, 2007

(30) Foreign Application Priority Data
May 31, 2006 (DE) 10 2006 025 348.5

(51) Int. Cl. F16H 47/04

(52) U.S. Cl. 475/72

(57) ABSTRACT

The invention relates to a hydrostatic mechanical traction gearbox having a continuously variable hydrostatic drive in which the hydrostatic drive has a hydrostatic pump driven by an internal combustion engine and a hydraulic motor driven by the pump, the pump and the hydraulic motor are positively coupled in an adjustable fashion by means of a single common pivoting part in such a way that the pump can be pivoted between a minimum angle and a maximum angle while at the same time the motor pivots synchronously from a maximum pivot angle to a minimum angle. The pump is configured for a single delivery direction of the volume flow. A mechanical range change gearbox is connected downstream, said gearbox having a plurality of gear shifting stages which can be shifted by means of a clutch.

### BACKGROUND OF THE INVENTION

The invention relates to a hydrostatic-mechanical gearbox with a continuously variable hydrostatic drive and a mechanical range change gearbox connected downstream according to the features of claim 1.

Hydrostatic gearboxes are predominantly used in utility vehicles in the agricultural or construction industries. They are distinguished by the fact that they ensure a drive with a continuously variable transmission ratio within a certain speed range, said drive permitting the vehicle to be driven at an optimum engine speed and without interruption of the tractive force in any driving state.

Such continuously variable adjustable hydrostatic gearboxes are composed of a pump and one or more hydraulic motors which are of an oblique axis design or embodied as swashplate units. They can be, for example, part of a power divider gearbox in which the power which is applied by an internal combustion engine via the drive shaft is branched to the hydrostatic gearbox and the input shaft of a summing gearbox, the rotational speeds and torques of the hydrostatic gearbox and of the drive engine being combined again by the summing gearbox.

A power divider gearbox for tractors having a pump and two hydraulic motors is described, for example, in DE4209950 A1.

In a hydrostatic gearbox of the aforementioned type the pivot angle of the pump is zero in the neutral position so that there is virtually no volume flow. In contrast, in the neutral position the hydraulic motor is set to the maximum pivot angle. During operation the pump pivots from zero to its maximum pivot angle, for example, 45° in oblique axis drive units. The hydraulic motor then pivots from 45° to zero. The hydraulic pump is adjusted as a function of the power requirements which the driver predefines by actuating the accelerator pedal. The means for adjusting the hydraulic motor usually comprise a control device which ensures in each case optimum transmission of the tractive force to the axis.

### SUMMARY OF THE INVENTION

The present invention is intended to provide a continuously variable gearbox with simplified hydrostatics.

According to the invention this is achieved with a hydrostatic mechanical gearbox having a continuously variable hydrostatic drive with a hydrostatic pump driven by an internal combustion engine and a hydraulic motor driven by the pump in that the pump and the hydraulic motor are positively coupled in synchronism in an adjustable fashion in such a way that the pump can be pivoted between a minimum angle and a maximum angle, while at the same time the motor pivots from a maximum pivot angle to a minimum angle. The positive coupling is predefined mechanically by a single common pivoting part. The pump is configured here for a single delivery direction of the volume flow. A mechanical range change gearbox is connected downstream of the hydraulic motor, said gearbox having a plurality of gear shifting stages which can be shifted by means of a clutch.

The minimum pivot angle is essentially zero. In order to compensate possible volume flow losses the value can also deviate therefrom by several angle degrees.

The hydrostatic mechanical gearbox is preferably configured in such a way that the volume flow in its entirety, that is to say also in the hydraulic motor, flows only in a single direction, a reverse gear speed then being provided in the range change gearbox. Alternatively, a changeover valve can be provided which in order to change over the direction of travel connects the pump line either in parallel or in crisscross fashion to the fluid lines of the hydraulic motor. A particularly simple solution for this is a 4/2-way valve. A 4/3-way valve which during the switching over process firstly assumes a center position in which the hydraulic motor is disconnected from the pump lines also provides advantages.

The gearbox is preferably embodied as a power divider gearbox. In one advantageous development the range change gearbox has a plurality of forward gear speeds. Individual gear shifting stages or all the gear shifting stages of the range change gearbox can be synchronized here.

In one development of the inventive idea the gearbox 20 has power shifting clutches for shifting the gear shifting stages. In particular, it is advantageous if a power shifting clutch is provided between the hydraulic motor and the mechanical gearbox.

### BRIEF DESCRIPTION OF THE DRAWINGS

The pump and/or the hydraulic motor of the hydrostatic gearbox are oblique axis drive units. They can advantageously be combined in a common housing with two parallel axes and mechanically positively coupled to one another by means of the pivoting part. In an alternative embodiment the drive units can be of a swashplate design. In this case they are also preferably combined in a common housing. In all cases, particularly short hydraulic connections are produced so that complicated bushings and the resulting sealing problems are avoided.

Further features and advantages of the invention emerge from the following description of exemplary embodiments.

In the drawings:

FIG. 1 shows a first exemplary embodiment of a compact gearbox;

FIG. 2 shows a power divider gearbox with three forward gear shifting stages connected downstream and one reverse gear speed;

FIG. 3 shows a power divider gearbox with a power shifting clutch between the hydraulic motor and mechanical gearbox;

FIG. 4 shows a power divider gearbox with power shifting gear shifting stages 1 and R;

FIG. 5 shows a further exemplary embodiment of a power divider gearbox in which all the gear speeds can be power shifted;

FIG. 6 shows a further exemplary embodiment of a power divider gearbox of a compact design;

FIG. 7 shows a power divider gearbox with a 4/2-way valve between the pump and motor for changing between forward travel and reverse travel; and

FIG. 8 shows the power divider gearbox from FIG. 7 with a 4/3-way valve.

### DETAILED DESCRIPTION OF THE PREFERRED EMBODIMENT

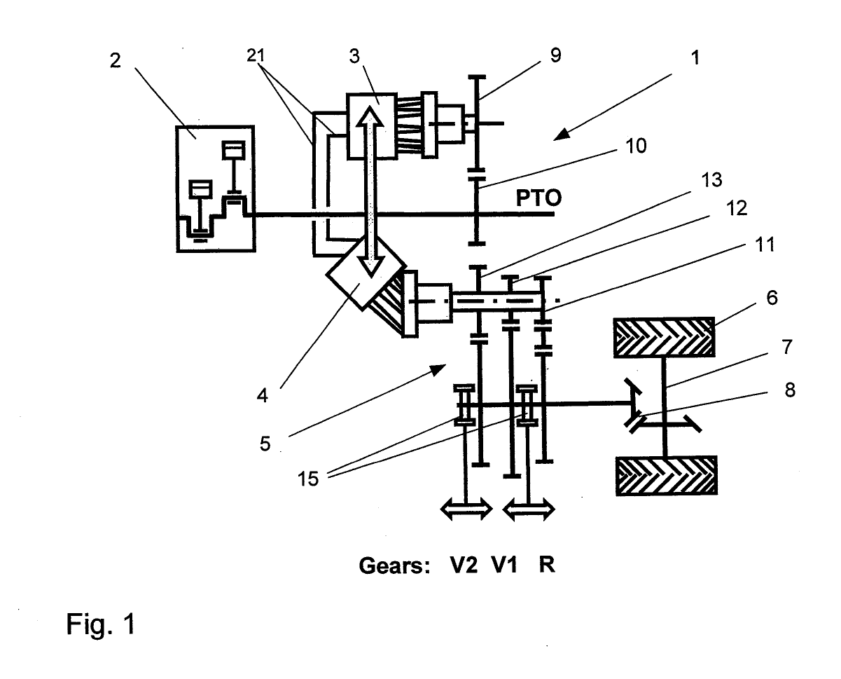

FIG. 1 illustrates a hydrostatic mechanical compact gearbox 1 according to the invention in which gearbox an internal combustion engine 2 drives a pump 3 via the gear wheels 9 and 10. The pump 3 supplies via the hydraulic lines 21 a hydraulic motor 4 downstream of which a mechanical gearbox 5 is connected. The shaft of the internal combustion engine 2 is guided through the gearbox 1 and serves as a PTO connection or power takeoff.

The pump 3 and the hydraulic motor 4 are each of the oblique axis design and are in the neutral position in the illustration in FIG. 1. This means the non delivery state for the pump, that is to say a pivot angle of zero degrees in which case for compensation reasons the minimum pivot angle which differs somewhat from zero degrees can, if appropriate, be selected. In an analogous fashion it is also possible to use swashplate drive units for the pump and motor.

The hydraulic motor 4 is at the maximum pivot angle, that is to say for example 45°, in the neutral position. It is mechanically positively coupled to the pump by means of a single piece pivoting part and therefore pivots in synchronism with it. If the pump 2 is adjusted from the neutral position in the direction of the maximum pivot angle in the driving mode, the hydraulic motor pivots simultaneously in the opposite direction, that is to say, in the direction of the minimum pivot angle. The hydraulic motor can therefore no longer be controlled independently. A separate control for adjusting the motor is dispensed with. Furthermore, the volume flow now only flows in one direction, i.e., in this exemplary embodiment it does not reverse its direction, for example, in order to travel in reverse.

A range change gearbox 5 is provided between the hydraulic motor 4 and the differential 8 between the rear wheels 6 on the rear wheel axis 7. Said range change gearbox 5 comprises a reverse gear speed R which can be connected to the hydraulic motor 4 via the gearwheel stage 11 as well as two forward gear speeds V1, V2 to which the gearwheel stages 12 and 13 are assigned, these gear shifting stages each being connected by means of a synchronizing clutch 15. As a result, it is possible for example, for the range from 0 km/h to 20 km/h to be covered for the reverse gear speed and the first forward gear speed and the range from 0 km/h to 40 km/h to be covered for V2, respectively.

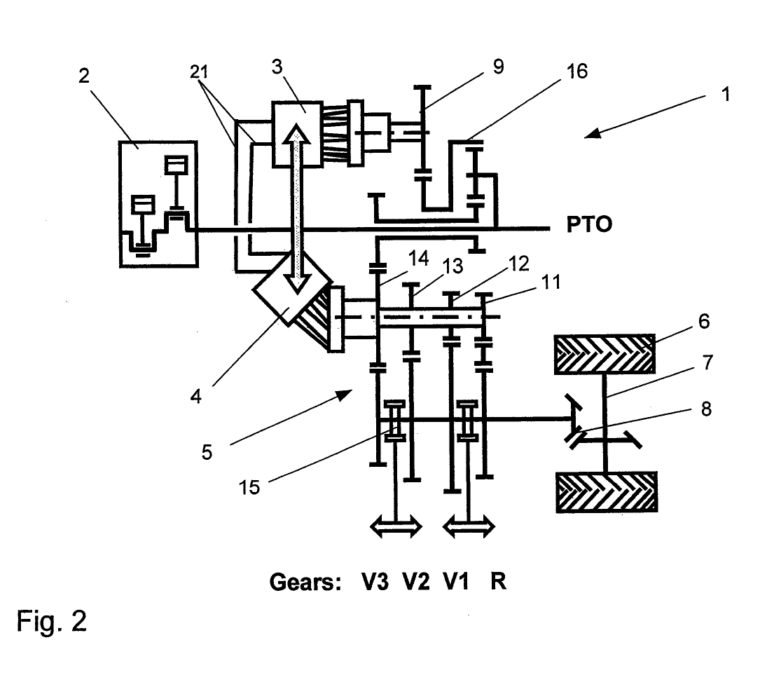

FIGS. 2-5 show various embodiments of a power divider gearbox 1 according to the invention which is equipped with a previously described continuously variable hydrostatic drive. In these examples the shaft of the internal combustion engine 2 which as previously described also leads to the PTO connection, is connected to a power branching planetary gear mechanism 16. A shaft of the planetary gear mechanism 16 drives an adjustable pump 3 via the gear wheel 9 and a further shaft connects the planetary gear mechanism 16 via the gear wheel stage 14 to the shaft of the hydraulic motor 4 and via one of the gearbox stages 11, 12, 13, 14 to the output shaft of the range change gearbox 5 which shaft in turn directly drives the differential 8 and the wheels 6 of the rear axis 7.

The hydraulic motor 4 is supplied by the pump 3 via hydraulic lines 21 and as previously described, is positively adjusted together with the pump 2, the pump being adjusted out of the neutral position in the region of the pivot angle zero degrees to the maximum pivot angle while the hydraulic motor 4 simultaneously pivots from the maximum angle to the minimum angle. A reversal of direction of the volume flow between the pump 3 and motor 4 is not provided.

A mechanical gearbox 5 for splitting the transmission ratio is connected to the shaft of the hydraulic motor 4, said gearbox 5 comprising a reverse gear speed R and three forward gear speeds V1, V2, V3. As a result, the following speed ranges are obtained, for example, in the reverse gear speed and first forward gear speed: 0 km/h to 20 km/h; in the second gear speed V2: 0 km/h to 35 km/h; in the third gear shifting stage V3: 0 km/h to 60 km/h.

According to the example in FIG. 2 the gearbox stages are each connected via a synchronizing clutch 15 and optionally one of the gearwheel sets 11, 12, 13, 14.

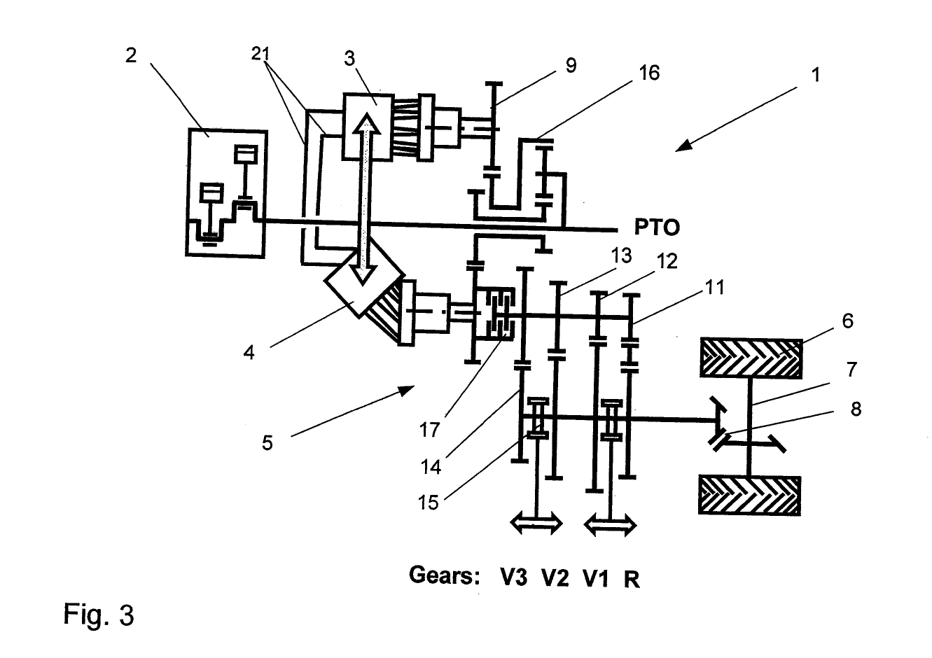

According to FIG. 3, in addition a multi disk clutch 17, which can perform power shifting and can shift at asynchronous rotational speeds, is additionally provided at the hydraulic motor 4.

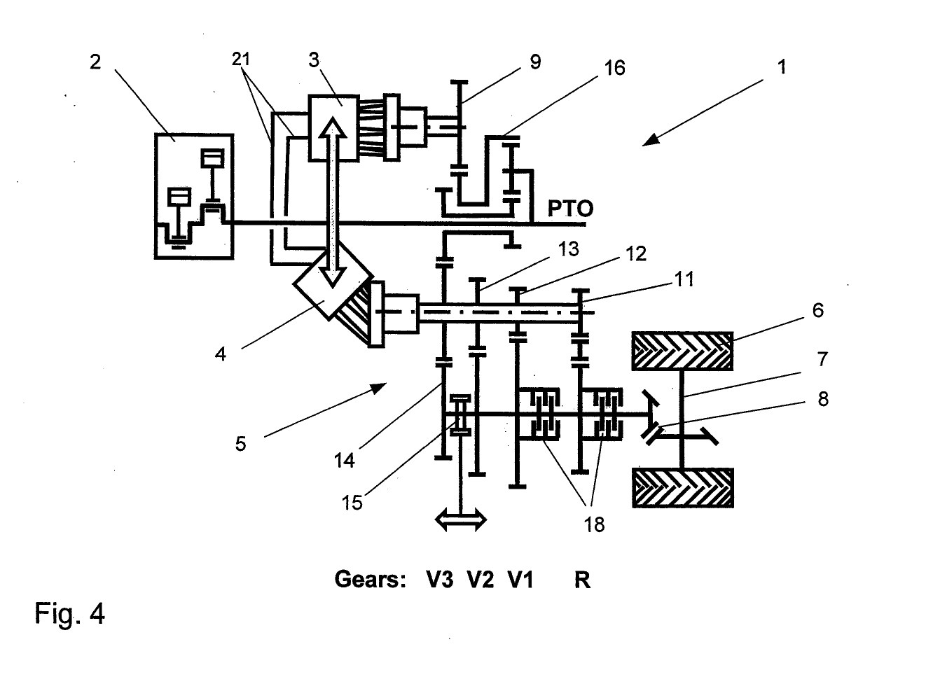

The example in FIG. 4 differs from the gearbox according to FIG. 2 in that the gear speeds 1 and R are designed so as to be capable of being power shifted with a multi disk clutch 18 while the gear speeds V2 and V3 are actuated by means of a synchronizing clutch.

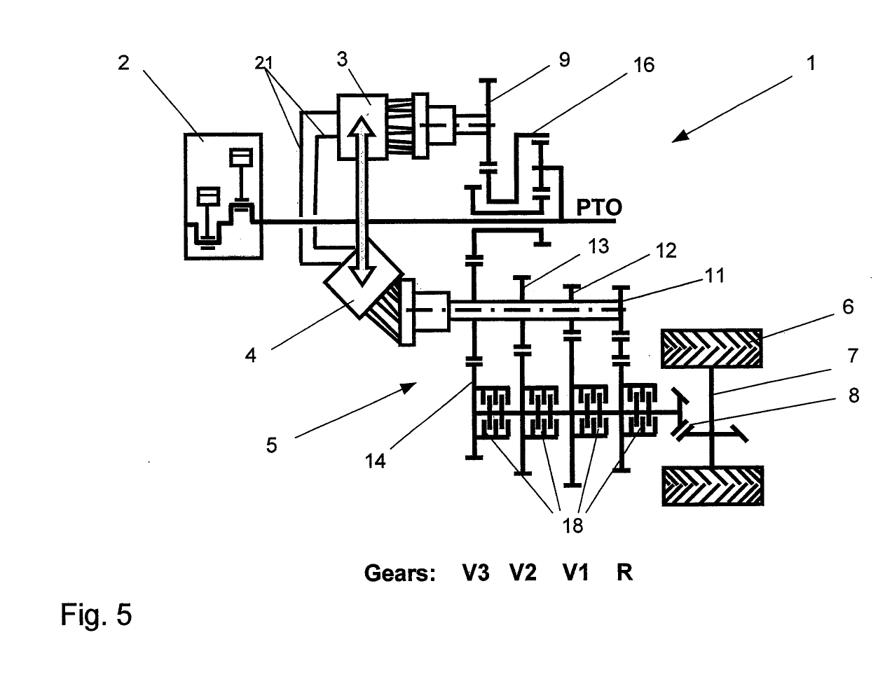

In the embodiment according to FIG. 5 all the gear speeds R, V1, V2, V3 are respectively designed so as to be capable of being power shifted with a multi disk clutch 18.

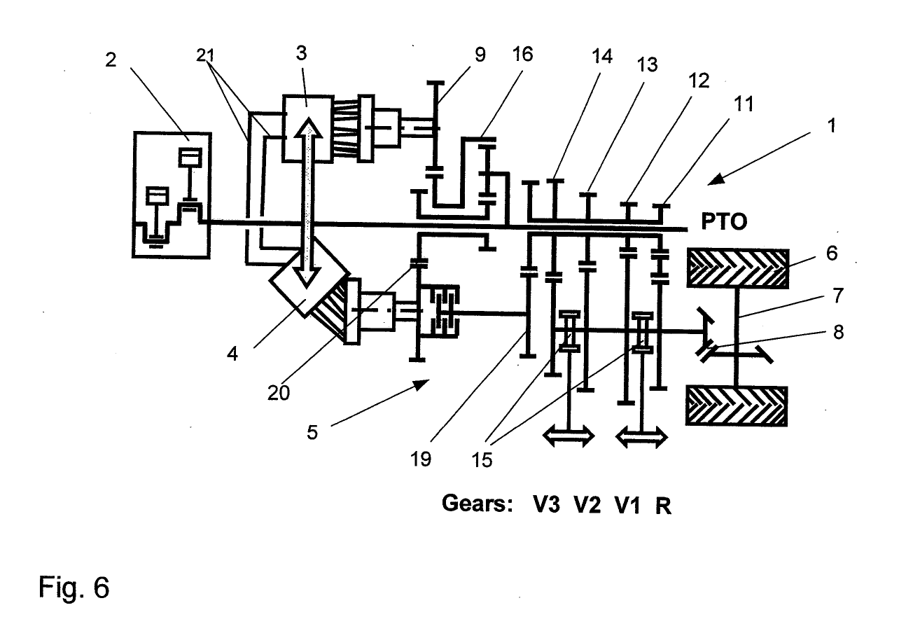

A further embodiment of a power divider gearbox of a compact design which provides space advantages is illustrated in FIG. 6. As in the previous examples, an adjustment pump 3 is driven by an internal combustion engine 2 via a planetary system 16 and a gearwheel stage 9. A further shaft of the planetary gear mechanism 16 is connected directly to the shaft of the hydraulic motor 4 via the gearwheel stage 20. In addition, a power shiftable multi disk clutch 17 is provided on this shaft and it can be used to transmit the drive force via the gearwheel stage 19 to a drive shaft which is arranged coaxially with respect to the shaft of the internal combustion engine. This coaxial drive shaft can be in turn be connected via gearbox stages for a reverse gear speed 11 and three forward gear speeds 12, 13, 14 and the synchronizing clutches 15 to the shaft which drives the differential 8 at the drive wheels 6 on the rear axis 7.

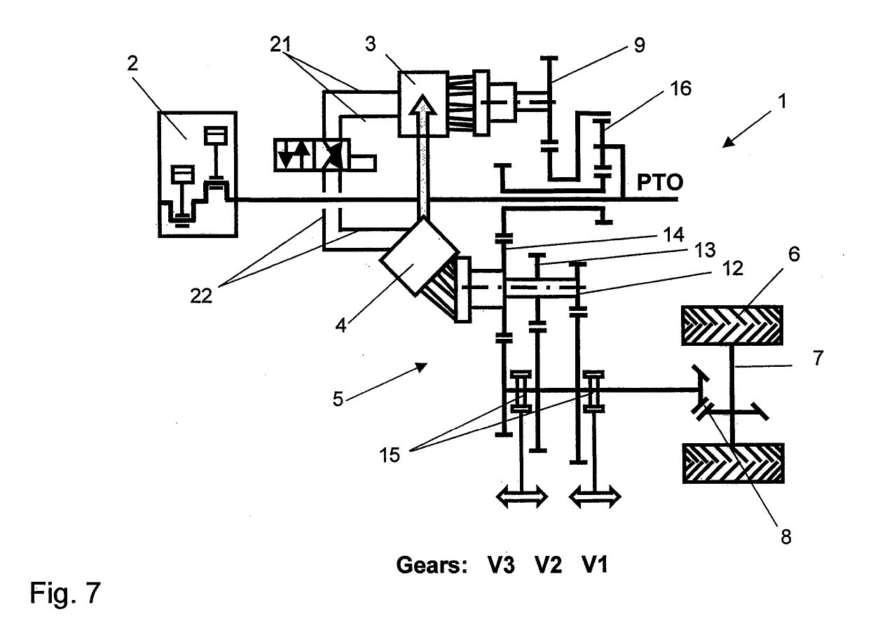

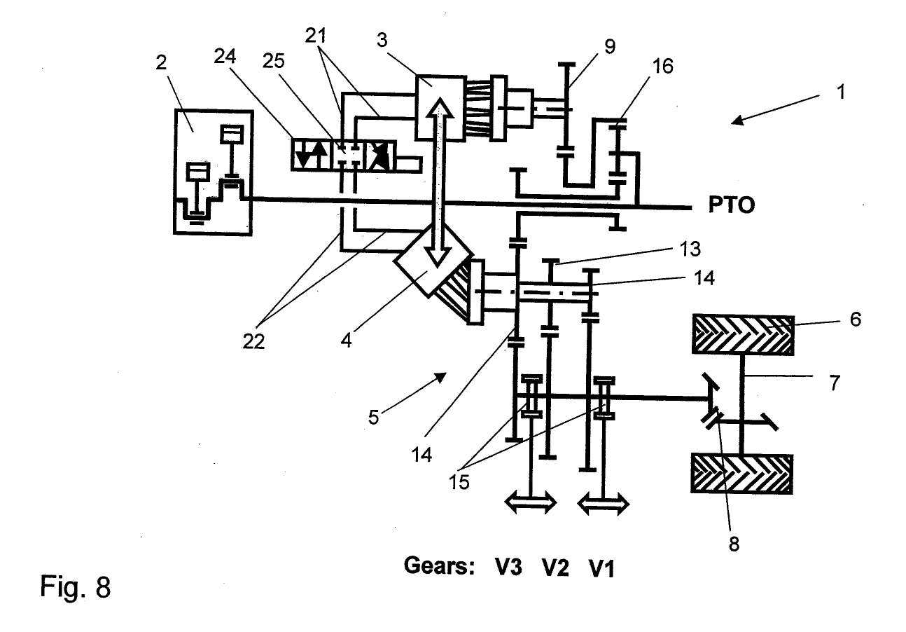

FIG. 7 illustrates a further power divider gearbox in which instead of a reverse gear speed, a changeover valve 23 in the form of a 4/2-way valve is provided between the pump 3 and motor 4. The changeover valve 23 connects the fluid lines 21 coming from the pump 3 to the lines 23 leading to the hydraulic motor 4, either in parallel or in crisscross fashion and thus, provides the possibility of changing over between forward travel and reverse travel. A separate reverse gear speed in the mechanical range change gearbox can thus be dispensed with. The other gearbox parts correspond to the previously described exemplary embodiments. Their reference symbols have been retained. The same applies to FIG. 8 which shows the same power divider gearbox but with a 4/3-way valve 24 for changing over the volume flow between the pump 3 and motor 4. The 4/3-way valve provides the advantage that it has a center position 25 in which the hydraulic motor is disconnected from the pressure, as a result of which the hydraulic motor is switched off in the 0° position and compression losses are eliminated.

The mechanical positive coupling of the pump and motor 20 thus permits advantageous gearboxes with simplified and robust hydrostatics to be implemented in a cost effective way.

What is claimed is:

1. Hydrostatic mechanical gearbox having a continuously variable hydrostatic drive, in which:
the hydrostatic drive has a hydrostatic pump (3) driven by an internal combustion engine (2), and a hydraulic motor (4.) driven by the pump (3);
the pump (3) and the hydraulic motor (4) are mechanically positively coupled in an adjustable fashion by means of a single common pivoting part in such a way that the pump (3) can be pivoted between a minimum angle and a maximum angle, while at the same time the motor (4) pivots synchronously from a maximum pivot angle to a minimum angle;
the pump (3) is configured for a single delivery 20 direction of the volume flow; and
a mechanical range change gearbox (5) is connected downstream, said gearbox having a plurality of gear shifting stages which can be shifted by means of a clutch (15, 17, 18).

2. Gearbox according to claim 1 in which the minimum angle is in the region of 0°.

3. Gearbox according to claim 1 which the volume flow in the hydraulic motor (4) flows in a single direction and the gear shifting stages of the range change gearbox (5) have a reverse gear speed (R).

4. Gearbox according to claim 1 in which a changeover valve (23, 24) is provided which in order to travel in reverse connects the fluid lines (21) leading from the pump (3) to the hydraulic motor (4) to the fluid lines (22) of the hydraulic motor (4) in a crisscross fashion.

5. Gearbox according to claim 4 in which the changeover valve is a 4/2-way valve (23).

6. Gearbox according to claim 4 in which the changeover valve (24) has a center position (25) in which the hydraulic motor (4) is disconnected from the pump lines (21).

7. Gearbox according to claim 6 in which the changeover valve is a 4/3-way valve (24).

8. Gearbox according to claim 1 which is embodied as a power divider gearbox.

9. Gearbox according to claim 1 which has a range change gearbox (5) with a plurality of forward gear speeds (V1, V2, V3).

10. Gearbox according to claim 1 in which the gear shifting stages of the range change gearbox (5) are synchronized.

11. Gearbox according to claim 1 which has power shifting clutches (17, 18) for shifting the gear shifting stages.

12. Gearbox according to claim 1 which has a power shifting clutch (17) between the hydraulic motor and the downstream range change gearbox (5).

13. Gearbox according to claim 1 in which the coupling of the pivot angles between the pump (3) and hydraulic motor (4) is carried out mechanically by means of a common pivoting part.

14. Gearbox according to claim 1 in which the pump (3) and the hydraulic motor (4) are embodied as oblique axis drive units.

15. Gearbox according to claim 1 in which the pump (3) and the hydraulic motor (4) are embodied as swashplate drive units.

16. Gearbox according to claim 1 in which the pump (3) and hydraulic motor (4) are combined as one assembly in a common housing.
